(19) United States
(12) Patent Application Publication
(10) Pub. No.: US 2026/0344671 A1
(43) Pub. Date: Nov. 5, 2026

(54) BIXLOZONE WATER DISPERSIBLE GRANULE COMPOSITIONS

(71) Applicant: FMC CORPORATION, Philadelphia, PA (US)

(72) Inventors: Luann Rue MARSHALL, Newark, DE (US); Jeffrey Wayne SHIMP, Newark, DE (US); Paul NICHOLSON, Ewing, NJ (US)

(21) Appl. No.: 19/116,452

(22) PCT Filed: Sep. 29, 2023
(86) PCT No.: PCT/US2023/034071

§ 371 Date: Mar. 28, 2025

Related U.S. Application Data
(60) Provisional application No. 63/412,059, filed on Sep. 30, 2022.

(51) Int. Cl. A01N 43/80; A01N 25/14; A01P 13/00

(52) U.S. Cl. CPC A01N 43/80; A01N 25/14; A01P 13/00

(57) ABSTRACT

Described herein are water dispersible granule (WG) compositions including bixlozone. Also described herein are methods of preparing the compositions. Also described herein are methods for controlling undesirable vegetation with the compositions.

### FIELD OF THE DISCLOSURE

Described herein are water dispersible granule (WG) compositions comprising bixlozone. Also described herein are methods of preparing the compositions. Also described herein are methods for controlling undesirable vegetation with the compositions.

### BACKGROUND OF THE DISCLOSURE

Liquid suspension concentrate (SC) compositions are prone to settling of the dispersed solids during storage due to gravity. They require mixing and/or shaking before use in order to resuspend the settled material. In addition, SC compositions tend to leave about 3-5% residue when poured out of a container. SC compositions also present issues with safety and cleanup due to their liquid form.

Granular compositions, such as water dispersible granule (WG) compositions (A formulation consisting of granules to be applied after disintegration and dispersion in water), do not share the issues of SC compositions with settling, residue, safety, or cleanup. Thus, they present numerous benefits over SC compositions.

Effective WG compositions depend on the identity and amounts of the active ingredients and other components. However, effective WG compositions are often difficult to predict and formulate. As one example, conventional WG compositions including high amounts of bixlozone have not been formulated.

WG compositions including high amounts of bixlozone have been surprisingly discovered herein. These compositions overcome past limitations with SC compositions and WG compositions including low amounts of bixlozone.

### BRIEF DESCRIPTION OF THE DISCLOSURE

In one embodiment, the present disclosure is directed to a water dispersible granule composition comprising: (i) from greater than 50 wt % to about 90 wt % of bixlozone; (ii) from about 0.01 wt % to about 5 wt % of a wetting agent; (iii) from about 1 wt % to about 20 wt % of a dispersant; and (iv) from about 1 wt % to about 20 wt % of a carrier.

In another embodiment, the present disclosure is directed to a method of preparing a water dispersible granule composition, the method comprising: I) forming a mixture comprising: (i) bixlozone; (ii) a wetting agent; (iii) a dispersant; and (iv) a carrier; and II) granulating the mixture.

In yet another embodiment, the present disclosure is directed to a method for controlling undesirable vegetation, the method comprising: I) forming a mixture by dissolving in water a water dispersible granule composition comprising: (i) from greater than 50 wt % to about 90 wt % of bixlozone; (ii) from about 0.01 wt % to about 5 wt % of a wetting agent; (iii) from about 1 wt % to about 20 wt % of a dispersant; (iv) from about 1 wt % to about 20 wt % of a carrier; and II) applying the mixture to the undesirable vegetation or to a locus thereof or applying to a soil or water to prevent an emergence or growth of the undesirable vegetation.

### DETAILED DESCRIPTION OF THE DISCLOSURE

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, depending on the context in which it is used, the term “about” provides an estimate of a value associated with the claimed invention, where the estimated value is reasonable when taken in context with the description of the invention and in view of what is known from information available to the public, as such information would be understood or interpreted by a person of ordinary skill in the art. Generally, the term “about” as used herein means that the estimated value will fall within plus or minus 10% of the associated value. Bixlozone is a herbicide recently introduced by FMC with the CAS name of 2-(2,4-dichlorophenyl)methyl-4,4-dimethyl-3-isoxazolidinone. For convenience, bixlozone is sold commercially as (a formulated material as) “Overwatch” and has also been referred to as “DCPMI”, “F9600”, “2,4-DC” and “dichloroclomazone”. The term “bixlozone” as used herein means a composition comprising at least 90% by weight pure 2-(2,4-dichlorophenyl)methyl-4,4-dimethyl-3-isoxazolinone. In one embodiment bixlozone may be technical grade bixlozone with purity range of 90 to 95% by weight. In another embodiment, the bixlozone may be a composition comprising more than 95% by weight pure 2-(2,4-dichlorophenyl)methyl-4,4-dimethyl-3-isoxazolinone. The term “pure bixlozone” means 100% pure 2-(2,4-dichlorophenyl)methyl-4,4-dimethyl-3-isoxazolinone.

As used herein, “wt %” refers to the weight percent of the recited component relative to the total weight of the recited composition.

Embodiments of this disclosure can be combined in any manner.

Composition embodiments of the present disclosure include:

Embodiment A1. The composition described in the Summary of the Invention, wherein component (i) is at least about 55 wt % of bixlozone.

Embodiment A2. The composition described in Embodiment A1, wherein component (i) is at least about 60 wt % of bixlozone.

Embodiment A3. The composition described in Embodiment A2, wherein component (i) is at least about 65 wt % of bixlozone.

Embodiment A4. The composition described in Embodiment A3, wherein component (i) is at least about 70 wt % of bixlozone.

Embodiment A5. The composition described in Embodiment A4, wherein component (i) is at least about 72 wt % of bixlozone.

Embodiment A6. The composition described in Embodiment A5, wherein component (i) is at least about 75 wt % of bixlozone.

Embodiment A7. The composition described in Embodiment A6, wherein component (i) is at least about 80 wt % of bixlozone.

Embodiment A8. The composition described in Embodiment A7, wherein component (i) is at least about 85 wt % of bixlozone.

Embodiment A9. The composition described in the Summary of the Invention, wherein component (i) is no more than about 85 wt % of bixlozone.

Embodiment A10. The composition described in Embodiment A9, wherein component (i) is no more than about 80 wt % of bixlozone.

Embodiment A11. The composition described in Embodiment A10, wherein component (i) is no more than about 77 wt % of bixlozone.

Embodiment A12. The composition described in the Summary of the Invention, wherein component (i) is about 75 wt % of bixlozone

Embodiment B1. The composition described in the Summary of the Invention, wherein component (ii) is at least about 0.1 wt % of a wetting agent.

Embodiment B2. The composition described in Embodiment B1, wherein component (ii) is at least about 0.5 wt % of a wetting agent.

Embodiment B3. The composition described in Embodiment B2, wherein component (ii) is at least about 1 wt % of a wetting agent.

Embodiment B4. The composition described in the Summary of the Invention, wherein component (ii) is no more than about 4 wt % of a wetting agent.

Embodiment B5. The composition described in Embodiment B4, wherein component (ii) is no more than about 3 wt % of a wetting agent.

Embodiment B6. The composition described in Embodiment B5, wherein component (ii) is no more than about 2 wt % of a wetting agent.

Embodiment B7. The composition described in the Summary of the Invention, wherein component (ii) is about 1 wt % of a wetting agent.

Embodiment B8. The composition described in the Summary of the Invention, wherein the wetting agent is selected from alkaline earth or ammonium salts of sulfonates, alkylarylsulfonates, sulfonates of dodecyl- and tridecylbenzenes, sodium dodecylbenzenesulfonate, and combinations thereof.

Embodiment B9. The composition described in Embodiment B8, wherein the wetting agent is sodium dodecylbenzenesulfonate.

Embodiment C1. The composition described in the Summary of the Invention, wherein component (iii) is at least about 2 wt % of a dispersant.

Embodiment C2. The composition described in Embodiment C1, wherein component (iii) is at least about 3 wt % of a dispersant.

Embodiment C4. The composition described in Embodiment C5, wherein component (iii) is at least about 4 wt % of a dispersant.

Embodiment C5. The composition described in Embodiment C4, wherein component (iii) is at least about 5 wt % of a dispersant.

Embodiment C6. The composition described in Embodiment C5, wherein component (iii) is at least about 6 wt % of a dispersant.

Embodiment C7. The composition described in Embodiment C6, wherein component (iii) is at least about 7 wt % of a dispersant.

Embodiment C8. The composition described in Embodiment C7, wherein component (iii) is at least about 8 wt % of a dispersant.

Embodiment C9. The composition described in Embodiment C8, wherein component (iii) is at least about 9 wt % of a dispersant.

Embodiment C10. The composition described in Embodiment C9, wherein component (iii) is at least about 10 wt % of a dispersant.

Embodiment C11. The composition described in Embodiment C10, wherein component (iii) is at least about 11 wt % of a dispersant.

Embodiment C12. The composition described in Embodiment C11, wherein component (iii) is at least about 12 wt % of a dispersant.

Embodiment C13. The composition described in the Summary of the Invention, wherein component (iii) is no more than about 19 wt % of a dispersant.

Embodiment C14. The composition described in Embodiment C13, wherein component (iii) is no more than about 18 wt % of a dispersant.

Embodiment C15. The composition described in Embodiment C14, wherein component (iii) is no more than about 17 wt % of a dispersant.

Embodiment C16. The composition described in Embodiment C15, wherein component (iii) is no more than about 16 wt % of a dispersant.

Embodiment C17. The composition described in Embodiment C16, wherein component (iii) is no more than about 15 wt % of a dispersant.

Embodiment C18. The composition described in Embodiment C17, wherein component (iii) is no more than about 14 wt % of a dispersant.

Embodiment C19. The composition described in Embodiment C18, wherein component (iii) is no more than about 13 wt % of a dispersant.

Embodiment C20. The composition described in the Summary of the Invention, wherein component (iii) is about 12 wt % of a dispersant.

Embodiment C21. The composition described in the Summary of the Invention, wherein component (iii) is a combination of dispersants.

Embodiment C22. The composition described in Embodiment C21, wherein component (iii) is a combination of at least two dispersants.

Embodiment C23. The composition described in Embodiment C22, wherein component (iii) is a combination of at least three dispersants.

Embodiment C24. The composition described in Embodiment C23, wherein component (iii) is a combination of at least four dispersants.

Embodiment C25. The composition described in the Summary of the Invention, wherein component (iii) is a dispersant selected from sodium polycarboxylate, copolymers of maleic anhydride and diisobutylene sodium salt and sodium dodecylbenzenesulfonate, sulfonated aromatic condensates, alkyl naphthalene sulfonates, lignosulfonate dispersants, and combinations thereof.

Embodiment C26. The composition described in Embodiment C25, wherein component (iii) is a combination of copolymers of maleic anhydride and diisobutylene sodium salt and sodium dodecylbenzenesulfonate and sulfonated aromatic condensates.

Embodiment D1. The composition described in the Summary of the Invention, wherein component (iv) is at least about 2 wt % of a carrier.

Embodiment D2. The composition described in Embodiment D1, wherein component (iv) is at least about 3 wt % of a carrier.

Embodiment D3. The composition described in Embodiment D2, wherein component (iv) is at least about 4 wt % of a carrier.

Embodiment D4. The composition described in Embodiment D3, wherein component (iv) is at least about 5 wt % of a carrier.

Embodiment D5. The composition described in Embodiment D4, wherein component (iv) is at least about 6 wt % of a carrier.

Embodiment D6. The composition described in Embodiment D5, wherein component (iv) is at least about 7 wt % of a carrier.

Embodiment D7. The composition described in Embodiment D6, wherein component (iv) is at least about 8 wt % of a carrier.

Embodiment D8. The composition described in Embodiment D7, wherein component (iv) is at least about 9 wt % of a carrier.

Embodiment D9. The composition described in the Summary of the Invention, wherein component (iv) is no more than about 19 wt % of a carrier.

Embodiment D10. The composition described in Embodiment D9, wherein component (iv) is no more than about 18 wt % of a carrier.

Embodiment D11. The composition described in Embodiment D10, wherein component (iv) is no more than about 17 wt % of a carrier.

Embodiment D12. The composition described in Embodiment D11, wherein component (iv) is no more than about 16 wt % of a carrier.

Embodiment D13. The composition described in Embodiment D12, wherein component (iv) is no more than about 15 wt % of a carrier.

Embodiment D14. The composition described in Embodiment D13, wherein component (iv) is no more than about 14 wt % of a carrier.

Embodiment D15. The composition described in Embodiment D14, wherein component (iv) is no more than about 13 wt % of a carrier.

Embodiment D16. The composition described in Embodiment D15, wherein component (iv) is no more than about 12 wt % of a carrier.

Embodiment D17. The composition described in Embodiment D16, wherein component (iv) is no more than about 11 wt % of a carrier.

Embodiment D18. The composition described in Embodiment D17, wherein component (iv) is no more than about 10 wt % of a carrier.

Embodiment D19. The composition described in the Summary of the Invention, wherein component (iv) is about 9 wt % of a carrier.

Embodiment D20. The composition described in the Summary of the Invention, wherein component (iv) is a carrier selected from mineral earths, clay, kaolin clay, and combinations thereof.

Embodiment D21. The composition described in Embodiment D20, wherein component (iv) is kaolin clay.

Embodiment E1. The composition described in the Summary of the Invention, further comprising a defoamer.

Embodiment E2. The composition described in Embodiment E1, wherein the defoamer is present in an amount of from about 0.01 wt % to about 5 wt %.

Embodiment E3. The composition described in Embodiment E2, wherein the defoamer is present in an amount of at least about 0.1 wt %.

Embodiment E4. The composition described in Embodiment E3, wherein the defoamer is present in an amount of at least about 0.5 wt %.

Embodiment E5. The composition described in Embodiment E4, wherein the defoamer is present in an amount of at least about 1 wt %.

Embodiment E6. The composition described in Embodiment E2, wherein the defoamer is present in an amount of no more than about 4 wt %.

Embodiment E7. The composition described in Embodiment E6, wherein the defoamer is present in an amount of no more than about 3 wt %.

Embodiment E8. The composition described in Embodiment E7, wherein the defoamer is present in an amount of no more than about 2 wt %.

Embodiment E9. The composition described in Embodiment E2, wherein the defoamer is present in an amount of about 1 wt %.

Embodiment E10. The composition described in Embodiment E1, wherein the defoamer is selected from silicones, long chain alcohols, fatty acids, salts of fatty acids, sodium tallowate, and combinations thereof.

Embodiment E11. The composition described in Embodiment E10, wherein the defoamer is sodium tallowate.

Embodiment F1. The composition described in the Summary of the Invention, further comprising a flow aid.

Embodiment F2. The composition described in Embodiment F1, wherein the flow aid is present in an amount of from about 0.01 wt % to about 5 wt %.

Embodiment F3. The composition described in Embodiment F2, wherein the flow aid is present in an amount of at least about 0.1 wt %.

Embodiment F4. The composition described in Embodiment F3, wherein the flow aid is present in an amount of at least about 0.5 wt %.

Embodiment F5. The composition described in Embodiment F4, wherein the flow aid is present in an amount of at least about 1 wt %.

Embodiment F6. The composition described in Embodiment F5, wherein the flow aid is present in an amount of at least about 2 wt %.

Embodiment F7. The composition described in Embodiment F2, wherein the flow aid is present in an amount of no more than about 4 wt %.

Embodiment F8. The composition described in Embodiment F7, wherein the flow aid is present in an amount of no more than about 3 wt %.

Embodiment F9. The composition described in Embodiment F2, wherein the flow aid is present in an amount of about 2 wt %.

Embodiment F10. The composition described in Embodiment F1, wherein the flow aid is selected from silicates, silica gel, amorphous silica, silica, and combinations thereof.

Embodiment F11. The composition described in Embodiment F10, wherein the flow aid is amorphous silica.

The composition embodiments of this disclosure may be combined in any manner. The following embodiments are, therefore, to be construed as merely illustrative, and not limiting of the disclosure in any way whatsoever.

Embodiment G. The composition described in the Summary of the Invention, comprising: (i) from about 65 wt % to about 80 wt % of bixlozone; (ii) from about 0.1 wt % to about 2 wt % of a wetting agent; (iii) from about 10 wt % to about 15 wt % of a dispersant; (iv) from about 5 wt % to about 15 wt % of a carrier; (v) from about 0.1 wt % to about 2 wt % of a defoamer; and (vi) from about 0.1 wt % to about 5 wt % of a flow aid.

Embodiment H. The composition described in the Summary of the Invention, consisting of: (i) from about 72 wt % to about 77 wt % of bixlozone; (ii) from about 0.1 wt % to about 2 wt % of a wetting agent; (iii) from about 10 wt % to about 15 wt % of a dispersant; (iv) from about 5 wt % to about 15 wt % of a carrier; (v) from about 0.1 wt % to about 2 wt % of a defoamer; and (vi) from about 0.1 wt % to about 5 wt % of a flow aid.

Embodiment I. The composition described in the Summary of the Invention, consisting of: (i) about 75 wt % of bixlozone; (ii) about 1 wt % of a wetting agent; (iii) about 12 wt % of a dispersant; (iv) about 9 wt % of a carrier; (v) about 1 wt % of a defoamer; and (vi) about 2 wt % of a flow aid.

Embodiment J. The composition described in the Summary of the Invention, consisting of:

| | | | Example Trade | |
|---|---|---|---|---|
| Wt % | Chemical Name | CAS No. | Name(s) | Functionality |
| 75 | Bixlozone | 81777-95-5 | N/A | Active ingredient |
| 1 | Benzenesulfonic acid, dodecyl- | 68608-89-9 or | Rhodocal | Wetting agent |
| | branched, sodium salt | 69227-09-4 | DS-10 | |
| 7 | Copolymer of maleic anhydride | 37199-81-8 | Geropon TA 72 | Dispersant |
| | and diisobutylene, sodium salt | | | |
| | and 5-10% sodium | | | |
| | dodecylbenzenesulfonate | | | |
| 5 | Sulfonated aromatic condensate, | 68425-94-5 | Morwet D425 | Dispersant |
| | sodium salt | | | |
| 1 | Sodium tallowate | 8052-48-0 | Agnique Soap L | Antifoam |
| 2 | Amorphous silica | 112926-00-8 | HiSil 233 | Flow aid |
| 9 | Kaolin clay | 1332-58-7 | Argirec B22 | Diluent/Carrier |

The composition embodiments of this disclosure may be combined with the methods of preparation embodiments of this disclosure in any manner. Similarly, the methods of preparation embodiments of this disclosure may be combined in any manner. The following embodiments are, therefore, to be construed as merely illustrative, and not limiting of the disclosure in any way whatsoever.

Methods of preparation embodiments of the present disclosure include:

Embodiment K1. The method of preparing a water dispersible granule composition described in the Summary of the Invention, wherein the mixture further comprises the defoamer of any of Embodiments E1-E11.

Embodiment K2. The method of preparing a water dispersible granule composition described in the Summary of the Invention, wherein the mixture further comprises the flow aid of any of Embodiments F1-F11.

Embodiment K3. The method of preparing a water dispersible granule composition described in the Summary of the Invention, wherein the method step of granulating the mixture occurs with a technique selected from paste extrusion, pan granulation, fluid bed granulation, and combinations thereof.

Embodiment K4. The method of preparing a water dispersible granule composition described in Embodiment K3, wherein the method step of granulating the mixture occurs with paste extrusion.

Embodiment K5. The method of preparing a water dispersible granule composition described in Embodiment K3, wherein the method step of granulating the mixture occurs with pan granulation.

Embodiment K6. The method of preparing a water dispersible granule composition described in Embodiment K3, wherein the method step of granulating the mixture occurs with fluid bed granulation.

Embodiment L. The method of preparing a water dispersible granule composition described in the Summary of the Invention, comprising: I) mixing and air-milling an active ingredient and other ingredients to produce a mixture having a median particle size of 5-8 micrometers; II) adding water to the mixture over about one minute and stirring the wetted mixture for an additional 3 minutes; III) feeding the wetted mixture into a paste extruder fitted with a 1 mm dome; and IV) drying the wet extrudate in a fluid bed with a 60-65 °C inlet temperature for about 10-12 minutes to provide the water dispersible granule with a moisture content of about <1.5%.

The composition embodiments of this disclosure may be combined with the methods for controlling undesirable vegetation embodiments of this disclosure in any manner. Similarly, the methods of preparation embodiments of this disclosure may be combined with the methods for controlling undesirable vegetation embodiments of this disclosure in any manner. Similarly, the methods for controlling undesirable vegetation embodiments of this disclosure may be combined in any manner. The following embodiments are, therefore, to be construed as merely illustrative, and not limiting of the disclosure in any way whatsoever.

Methods for controlling undesirable vegetation embodiments of the present disclosure include:

Embodiment M1. The method for controlling undesirable vegetation described in the Summary of the Invention, wherein the mixture further comprises the defoamer of any of Embodiments E1-E11.

Embodiment M2. The method for controlling undesirable vegetation described in the Summary of the Invention, wherein the mixture further comprises the flow aid of any of Embodiments F1-F11.

Embodiment M3. The method for controlling undesirable vegetation described in the Summary of the Invention, wherein the undesirable vegetation comprises at least one herbicide-resistant or herbicide-tolerant weed species.

Embodiment M4. The method for controlling undesirable vegetation described in the Summary of the Invention, wherein the undesirable vegetation comprises a broad leaf weed or a grass weed.

Embodiment M5. The method for controlling undesirable vegetation described in Embodiment M4, wherein the undesirable vegetation is selected from Abutilon theophrasti (ABUTH), Acalypha virginica (ACCVI), Alopecurus myosuroides (ALOMY), Amaranthus retroflexus (AMARE), Ambrosia artemisiifolia (AMBEL), Anagallis arvensis (ANGAR), Apera spica-venti (APESV), Arrhenatherum elatius (ARREB), Calystegia sepium (CAGSE), Capsella bursa-pastoris (CAPBP), Centaurea cyanus (CENCY), Chenopodium album (CHEAL), Chenopodium hybridum (CHEHY), Chenopodium polyspermum (CHEPO), Convolvulus arvensis (CONAR), Cynodon dactylon (CYNDA), Datura stramonium (DATST), Daucus carota (DAUCA), Descurainia sophia (DESSO), Digitaria sanguinalis (DIGSA), Echinochloa crus-galli (ECHCG), Fumaria officinalis (FUMOF), Galium aparine (GALAP), Galinsoga quadriradiata (GASCI), Geranium dissectum (GERDI), Geranium mole (GERMO), Geranium pusillum (GERPU), Hibiscus trionum (HIBTR), Lamium amplexicaule (LAMAM), Lamium purpureum (LAMPU), Buglossoides arvensis (LITAR), Lolium multiflorum (LOLMU), Lolium perenne (LOLPE), Matricaria chamomilla (MATCH), Tripleurospermum inodorum (MATIN), Mercurialis annua (MERAN), Panicum dichotomiflorum (PANDI), Panicum miliaceum (PANMI), Papaver rhoeas (PAPRH), Poa annua (POAAN), Polygonum aviculare (POLAV), Fallopia convolvulus (POLCO), Persicaria hydropiper (POLHY), Persicaria lapathifolia (POLLA), Persicaria maculosa (POLPE), Portulaca oleracea (POROL), Potentilla tridentate (PTLTR), Senecio vulgaris (SENVU), Setaria pumila (SETPU), Setaria viridis (SETVI), Solanum nigrum (SOLNI), Sorghum halepense (SORHA), Stellaria media (STEME), Trifolium incarnatum (TRFIN), Veronica arvensis (VERAR), Veronica hederifolia (VERHE), Veronica persica (VERPE), Viola arvensis (VIOAR), and Xanthium strumarium (XANST), and combinations thereof.

Embodiment M6. The method for controlling undesirable vegetation described in Embodiment M5, wherein the undesirable vegetation is Abutilon theophrasti (ABUTH).

Embodiment M7. The method for controlling undesirable vegetation described in Embodiment M5, wherein the undesirable vegetation is Acalypha virginica (ACCVI).

Embodiment M8. The method for controlling undesirable vegetation described in Embodiment M5, wherein the undesirable vegetation is Alopecurus myosuroides (ALOMY).

Embodiment M9. The method for controlling undesirable vegetation described in Embodiment M5, wherein the undesirable vegetation is Amaranthus retroflexus (AMARE).

Embodiment M10. The method for controlling undesirable vegetation described in Embodiment M5, wherein the undesirable vegetation is Ambrosia artemisiifolia (AMBEL).

Embodiment M11. The method for controlling undesirable vegetation described in Embodiment M5, wherein the undesirable vegetation is Anagallis arvensis (ANGAR).

Embodiment M12. The method for controlling undesirable vegetation described in Embodiment M5, wherein the undesirable vegetation is Apera spica-venti (APESV).

Embodiment M13. The method for controlling undesirable vegetation described in Embodiment M5, wherein the undesirable vegetation is Arrhenatherum elatius (ARREB).

Embodiment M14. The method for controlling undesirable vegetation described in Embodiment M5, wherein the undesirable vegetation is Calystegia sepium (CAGSE).

Embodiment M15. The method for controlling undesirable vegetation described in Embodiment M5, wherein the undesirable vegetation is Capsella bursa-pastoris (CAPBP).

Embodiment M16. The method for controlling undesirable vegetation described in Embodiment M5, wherein the undesirable vegetation is Centaurea cyanus (CENCY).

Embodiment M17. The method for controlling undesirable vegetation described in Embodiment M5, wherein the undesirable vegetation is Chenopodium album (CHEAL).

Embodiment M18. The method for controlling undesirable vegetation described in Embodiment M5, wherein the undesirable vegetation is Chenopodium hybridum (CHEHY).

Embodiment M19. The method for controlling undesirable vegetation described in Embodiment M5, wherein the undesirable vegetation is Chenopodium polyspermum (CHEPO).

Embodiment M20. The method for controlling undesirable vegetation described in Embodiment M5, wherein the undesirable vegetation is Convolvulus arvensis (CONAR).

Embodiment M21. The method for controlling undesirable vegetation described in Embodiment M5, wherein the undesirable vegetation is Cynodon dactylon (CYNDA).

Embodiment M22. The method for controlling undesirable vegetation described in Embodiment M5, wherein the undesirable vegetation is Datura stramonium (DATST).

Embodiment M23. The method for controlling undesirable vegetation described in Embodiment M5, wherein the undesirable vegetation is Daucus carota (DAUCA).

Embodiment M24. The method for controlling undesirable vegetation described in Embodiment M5, wherein the undesirable vegetation is Descurainia sophia (DESSO).

Embodiment M25. The method for controlling undesirable vegetation described in Embodiment M5, wherein the undesirable vegetation is Digitaria sanguinalis (DIGSA).

Embodiment M26. The method for controlling undesirable vegetation described in Embodiment M5, wherein the undesirable vegetation is Echinochloa crus-galli (ECHCG).

Embodiment M27. The method for controlling undesirable vegetation described in Embodiment M5, wherein the undesirable vegetation is Fumaria officinalis (FUMOF).

Embodiment M28. The method for controlling undesirable vegetation described in Embodiment M5, wherein the undesirable vegetation is Galium aparine (GALAP).

Embodiment M29. The method for controlling undesirable vegetation described in Embodiment M5, wherein the undesirable vegetation is Galinsoga quadriradiata (GASCI).

Embodiment M30. The method for controlling undesirable vegetation described in Embodiment M5, wherein the undesirable vegetation is Geranium dissectum (GERDI).

Embodiment M31. The method for controlling undesirable vegetation described in Embodiment M5, wherein the undesirable vegetation is Geranium mole (GERMO).

Embodiment M32. The method for controlling undesirable vegetation described in Embodiment M5, wherein the undesirable vegetation is Geranium pusillum (GERPU).

Embodiment M33. The method for controlling undesirable vegetation described in Embodiment M5, wherein the undesirable vegetation is Hibiscus trionum (HIBTR).

Embodiment M34. The method for controlling undesirable vegetation described in Embodiment M5, wherein the undesirable vegetation is Lamium amplexicaule (LAMAM).

Embodiment M35. The method for controlling undesirable vegetation described in Embodiment M5, wherein the undesirable vegetation is Lamium purpureum (LAMPU).

Embodiment M36. The method for controlling undesirable vegetation described in Embodiment M5, wherein the undesirable vegetation is Buglossoides arvensis (LITAR).

Embodiment M37. The method for controlling undesirable vegetation described in Embodiment M5, wherein the undesirable vegetation is Lolium multiflorum (LOLMU).

Embodiment M38. The method for controlling undesirable vegetation described in Embodiment M5, wherein the undesirable vegetation is Lolium perenne (LOLPE).

Embodiment M39. The method for controlling undesirable vegetation described in Embodiment M5, wherein the undesirable vegetation is Matricaria chamomilla (MATCH).

Embodiment M40. The method for controlling undesirable vegetation described in Embodiment M5, wherein the undesirable vegetation is Tripleurospermum inodorum (MATIN).

Embodiment M41. The method for controlling undesirable vegetation described in Embodiment M5, wherein the undesirable vegetation is Mercurialis annua (MERAN).

Embodiment M42. The method for controlling undesirable vegetation described in Embodiment M5, wherein the undesirable vegetation is Panicum dichotomiflorum (PANDI).

Embodiment M43. The method for controlling undesirable vegetation described in Embodiment M5, wherein the undesirable vegetation is Panicum miliaceum (PANMI).

Embodiment M44. The method for controlling undesirable vegetation described in Embodiment M5, wherein the undesirable vegetation is Papaver rhoeas (PAPRH).

Embodiment M45. The method for controlling undesirable vegetation described in Embodiment M5, wherein the undesirable vegetation is Poa annua (POAAN).

Embodiment M46. The method for controlling undesirable vegetation described in Embodiment M5, wherein the undesirable vegetation is Polygonum aviculare (POLAV).

Embodiment M47. The method for controlling undesirable vegetation described in Embodiment M5, wherein the undesirable vegetation is Fallopia convolvulus (POLCO).

Embodiment M48. The method for controlling undesirable vegetation described in Embodiment M5, wherein the undesirable vegetation is Persicaria hydropiper (POLHY).

Embodiment M49. The method for controlling undesirable vegetation described in Embodiment M5, wherein the undesirable vegetation is Persicaria lapathifolia (POLLA).

Embodiment M50. The method for controlling undesirable vegetation described in Embodiment M5, wherein the undesirable vegetation is Persicaria maculosa (POLPE).

Embodiment M51. The method for controlling undesirable vegetation described in Embodiment M5, wherein the undesirable vegetation is Portulaca oleracea (POROL).

Embodiment M52. The method for controlling undesirable vegetation described in Embodiment M5, wherein the undesirable vegetation is Potentilla tridentate (PTLTR).

Embodiment M53. The method for controlling undesirable vegetation described in Embodiment M5, wherein the undesirable vegetation is Senecio vulgaris (SENVU).

Embodiment M54. The method for controlling undesirable vegetation described in Embodiment M5, wherein the undesirable vegetation is Setaria pumila (SETPU).

Embodiment M55. The method for controlling undesirable vegetation described in Embodiment M5, wherein the undesirable vegetation is Setaria viridis (SETVI).

Embodiment M56. The method for controlling undesirable vegetation described in Embodiment M5, wherein the undesirable vegetation is Solanum nigrum (SOLNI).

Embodiment M57. The method for controlling undesirable vegetation described in Embodiment M5, wherein the undesirable vegetation is Sorghum halepense (SORHA).

Embodiment M58. The method for controlling undesirable vegetation described in Embodiment M5, wherein the undesirable vegetation is Stellaria media (STEME).

Embodiment M59. The method for controlling undesirable vegetation described in Embodiment M5, wherein the undesirable vegetation is Trifolium incarnatum (TRFIN).

Embodiment M60. The method for controlling undesirable vegetation described in Embodiment M5, wherein the undesirable vegetation is Veronica arvensis (VERAR).

Embodiment M61. The method for controlling undesirable vegetation described in Embodiment M5, wherein the undesirable vegetation is Veronica hederifolia (VERHE).

Embodiment M62. The method for controlling undesirable vegetation described in Embodiment M5, wherein the undesirable vegetation is Veronica persica (VERPE).

Embodiment M63. The method for controlling undesirable vegetation described in Embodiment M5, wherein the undesirable vegetation is Viola arvensis (VIOAR).

Embodiment M64. The method for controlling undesirable vegetation described in Embodiment M5, wherein the undesirable vegetation is Xanthium strumarium (XANST).

Embodiment M65. The method for controlling undesirable vegetation described in the Summary of the Invention, wherein the water dispersible granule composition is applied at a stage selected from pre-emergence, post-emergence, and combinations thereof.

Embodiment M66. The method for controlling undesirable vegetation described in Embodiment M65, wherein the water dispersible granule composition is applied at pre-emergence.

Embodiment M67. The method for controlling undesirable vegetation described in Embodiment M65, wherein the water dispersible granule composition is applied at post-emergence.

Embodiment M68. The method for controlling undesirable vegetation described in Embodiment M65, wherein the water dispersible granule composition is applied at pre-emergence and post-emergence.

Embodiment M69. The method for controlling undesirable vegetation described in Embodiment M4, wherein the undesirable vegetation is selected from annual blue grass, annual ryegrass (Lolium rigidum), ball medic (Medicago spp.), barley grass (Hordeum murinum), bedstraw (Galium tricornutum), Benghal dayflower, bifora (Bifora testiculata), black grass, black night shade, broadleaf signal grass, brome grass (Bromus spp.), Canada thistle, capeweed (Arctotheca calendula), cheat, chickweed (Stellaria media), common cocklebur (Xanthium pensylvanicum), common ragweed, corn poppies, doublegee (Emex australis), field violet, fleabane (Conyza bonariensis) giant foxtail, fumitory (Fumaria spp), goose grass, green fox tail, guinea grass, hairy beggarticks, herbicide-resistant black grass, horseweed, Indian hedge mustard (Sisymbrium orientale), Italian rye grass, Jersey cudweed (Gnaphalium luteoalbum), jimsonweed, johnsongrass (Sorghum halepense), large crabgrass, lesser loosestrife (Lythrum hyssopifolia), little seed cany grass, morning glory, Patterson's Curse (Echium plantagineum), Pennsylvania smartweed, phalaris (Phalaris paradoxa), pitted morningglory, prickly lettuce (Lactuca serriola), prickly sida, quack grass, redflowered mallow (Modiola caroliniana), redroot pigweed, rough poppy (Papaver hybridum), serradella, shatter cane, shepherd's purse, silky windgrass, silvergrass (Vulpia bromoides), sowthistle (Sonchus oleraceus), sub-clover (Trifolium spp.), sunflower (as weed in potato), volunteer chickpea, faba beans, field peas, lentils, lupins and vetch, wild buckwheat (Polygonum convolvulus), wild mustard (Brassica kaber), wild oat (Avena fatua), wild pointsettia, wild radish (Raphanus raphanistrum), wild turnip (Rapistrum rugosum, Brassica tournefortii), wireweed (Polygonum aviculare), yellow foxtail, yellow nutsedge (Cyperus esculentus).

Embodiment M70. The method of Embodiment M69, wherein the undesirable vegetation is selected from wild radish (Raphanus raphanistrum), velvetleaf, jimsonweed, common cocklebur and hairy beggarticks.

Embodiment M71. The method of Embodiment M70 wherein the undesirable vegetation is wild radish (Raphanus raphanistrum).

Generally, WG compositions in accordance with the present disclosure comprise bixlozone in an effective amount. An effective amount of bixlozone is any amount that has the ability to combat the harmful plants. The effectiveness of said WG compositions used in methods for the control of harmful plants will depend on various factors such as the mode of application, the harmful plants to be combated, the useful plant to be protected, the application time, etc. Methods of using of said effective compositions can be readily determined by the skilled person using well known principles.

In some embodiments, bixlozone is employed in an amount of from about 1 g/ha, about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha, to about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha. However, higher and lower doses may also provide adequate control.

Rates of application of the WG compositions will vary according to prevailing conditions such as targeted weeds, degree of infestation, weather conditions, soil conditions, crop species, mode of application, and application time.

WG compositions in accordance with the present disclosure may be formulated with further suitable formulation components known in the art. As non-limiting examples, WG compositions in accordance with the present disclosure may be formulated using known auxiliaries, adjuvants, diluents, solvents, dispersants, surfactants, protective colloids, thickeners, penetrating agents, stabilizers, sequestering agents, anti-caking agents, coloring agents, pigments, corrosion inhibitors, biocides, antifoamers, antifreeze agents, rheology modifiers, and combinations thereof.

WG compositions in accordance with the present disclosure may also be formulated with further suitable herbicides known in the art. An additional herbicide may be utilized if broadening of the spectrum of control or preventing the build-up of resistance is desired.

Examples of additional herbicides are acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), aminopyralid, amitrole, ammonium sulfamate, anilofos, asulam, atrazine, azimsulfuron, bixlozone, beflubutamid, beflubutamid-M, benazolin, benazolin-ethyl, bencarbazone, benfluralin, benfuresate, benquinotrione, bensulfuron-methyl, bensulide, bentazone, benzobicyclon, benzofenap, bicyclopyrone, bifenox, bilanafos, bipyrazone, bispyribac and its sodium salt, broclozone, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clacyfos, clefoxydim, clethodim, clodinafop-propargyl, clomazone, clomeprop, clopyralid, clopyralid-olamine, cloransulam-methyl, cumyluron, cyanazine, cycloate, cyclopyranil, cyclopyrimorate, cyclosulfamuron, cycloxydim, cyhalofop-butyl, cypyrafluone, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimesulfazet, dimepiperate, dimesulfazet, dimethachlor, dimethametryn, dimethenamid, dimethenamid-P, dimethipin, dimethylarsinic acid and its sodium salt, dinitramine, dinoterb, dioxopyritrione, diphenamid, diquat dibromide, dithiopyr, diuron, DNOC, endothal, EPTC, epyrifenacil, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fenpyrazone, fenquinotrione, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, fluchloraminopyr, flufenacet, flufenoximacil, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, flurochloridone, fluroxypyr, flurtamone, flusulfinam, fluthiacet-methyl, fomesafen, foramsulfuron, fosamine-ammonium, glufosinate, glufosinate-ammonium, L-glufosinate-ammonium, glufosinate-P, glyphosate and its salts such as ammonium, isopropylammonium, potassium, sodium (including sesquisodium) and trimesium (alternatively named sulfosate), halauxifen, halauxifen-methyl, halosulfuron-methyl, haloxyfop-etotyl, haloxyfop-methyl, hexazinone, hydantocidin, icafolin, imazamethabenz-methyl, imazamox, imazapic, imazapyr, imazaquin, imazaquin-ammonium, imazethapyr, imazethapyr-ammonium, imazosulfuron, indanofan, indaziflam, indolauxipyr, iofensulfuron, iodosulfuron-methyl, ioxynil, ioxynil octanoate, ioxynil-sodium, ipfencarbazone, iptriazopyrid, isoproturon, isouron, isoxaben, isoxaflutole, isoxachlortole, lactofen, lancotrione, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methylarsonic acid and its calcium, monoammonium, monosodium and disodium salts, methyldymron, metobenzuron, metobromuron, metolachlor, S-metolachlor, metosulam, metoxuron, metproxybicyclone, metribuzin, metsulfuron-methyl, molinate, monolinuron, naproanilide, napropamide, napropamide-M, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyrisulfuron, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriflubenzoxim, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimisoxafen, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, tetflupyrolimet, thenylchlor, thiazopyr, thiencarbazone, thifensulfuron-methyl, thiobencarb, tiafenacil, tiocarbazil, tolpyralate, topramezone, tralkoxydim, tri-allate, triafamone, triasulfuron, triaziflam, tribenuron-methyl, triclopyr, triclopyr-butotyl, triclopyr-triethylammonium, tridiphane, trietazine, trifloxysulfuron, trifludimoxazin, trifluralin, triflusulfuron-methyl, tripyrasulfone, tritosulfuron, vernolate, 3-(2-chloro-3,6-difluorophenyl)-4-hydroxy-1-methyl-1,5-naphthyridin-2(1H)-one, 6-chloro-4-(2,7-dimethyl-1-naphthalenyl)-5-hydroxy-2-methyl-3(2H)-pyridazinone, 5-chloro-3-[(2-hydroxy-6-oxo-1-cyclohexen-1-yl) carbonyl]-1-(4-methoxyphenyl)-2(1H)-quinoxalinone, 2-chloro-N-(1-methyl-1H-tetrazol-5-yl)-6-(trifluoromethyl)-3-pyridinecarboxamide, 7-(3,5-dichloro-4-pyridinyl)-5-(2,2-difluoroethyl)-8-hydroxypyrido[2,3-b]pyrazin-6(5H)-one), 4-(2,6-diethyl-4-methylphenyl)-5-hydroxy-2,6-dimethyl-3(2H)-pyridazinone), 5-[[(2,6-difluorophenyl) methoxy]methyl]-4,5-dihydro-5-methyl-3-(3-methyl-2-thienyl) isoxazole (previously methioxolin), 4-(4-fluorophenyl)-6-[(2-hydroxy-6-oxo-1-cyclohexen-1-yl) carbonyl]-2-methyl-1,2,4-triazine-3,5 (2H,4H)-dione, methyl 4-amino-3-chloro-6-(4-chloro-2-fluoro-3-methoxyphenyl)-5-fluoro-2-pyridinecarboxylate, 2-methyl-3-(methylsulfonyl)-N-(1-methyl-1H-tetrazol-5-yl)-4-(trifluoromethyl)benzamide and 2-methyl-N-(4-methyl-1,2,5-oxadiazol-3-yl)-3-(methylsulfinyl)-4-(trifluoromethyl)benzamide. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl, and Puccinia thlaspeos Schub.

Preferred for better control of undesirable vegetation (e.g., lower use rate such as from enhanced effects, broader spectrum of weeds controlled, or enhanced crop safety) or for preventing the development of resistant weeds are mixtures of a compound of this invention with a herbicide selected from atrazine, azimsulfuron, S-beflubutamid, benzisothiazolinone, carfentrazone-ethyl, chlorimuron-ethyl, chlorsulfuron-methyl, clomazone, clopyralid potassium, cloransulam-methyl, 2-[(2,5-dichlorophenyl)methyl]-4,4-dimethyl-3-isoxazolidinone, ethametsulfuron-methyl, flumetsulam, flupyrsulfuron-methyl, fluthiacet-methyl, fomesafen, imazethapyr, lenacil, mesotrione, metribuzin, metsulfuron-methyl, pethoxamid, picloram, pyroxasulfone, quinclorac, rimsulfuron, S-metolachlor, sulfentrazone, thifensulfuron-methyl, triflusulfuron-methyl and tribenuron-methyl.

More preferred for better control of undesirable vegetation (e.g., lower use rate such as from enhanced effects, broader spectrum of weeds controlled, or enhanced crop safety) or for preventing the development of resistant weeds are mixtures of a compound of this invention with a herbicide selected from azimsulfuron, benzisothiazolinone, carfentrazone-ethyl, chlorimuron-ethyl, chlorsulfuron-methyl, ethametsulfuron-methyl, flupyrsulfuron-methyl, fluthiacet-methyl, metribuzin, metsulfuron-methyl, pethoxamid, pyroxasulfone, rimsulfuron, sulfentrazone, thifensulfuron-methyl, triflusulfuron-methyl and tribenuron-methyl.

Most preferred for better control of undesirable vegetation (e.g., lower use rate such as from enhanced effects, broader spectrum of weeds controlled, or enhanced crop safety) or for preventing the development of resistant weeds are mixtures of a compound of this invention with a herbicide selected from carfentrazone-ethyl or sulfentrazone.

WG compositions in accordance with the present disclosure may also be formulated with further suitable safeners known in the art. A safener compound is a compound, which is effective for antagonism of the crop by bixlozone or any of the optional additional herbicide(s), and which is applied in a suitable amount i.e., an amount which counteracts to some degree a phytotoxic response of a useful plant to the herbicide(s). The safener may suitably be incorporated in the WG composition as a co-formulation added to the present bixlozone WG formulation or as a separate WG formulation that is subsequently blended with the present bixlozone WG formulation. The safener may also be in the form of a co-packed safener that is intended for use with the present bixlozone WG formulation and is provided with the present bixlozone WG formulation in a separate co-packed container. A co-packed safener may be a solid safener or a liquid safener. Safeners suitable for use include cloquintocet, cloquintocet-mexyl, benoxacor, dichlormid, fenchlorazole-ethyl, fenclorim, flurazole, fluxofenim, furilazole, isoxadifen, isoxadifen-ethyl, mefenpyr, mefenpyr-diethyl and oxabetrinil or their environmentally compatible salts, “acids”, esters and amides.

In some embodiments, the WG composition further comprises a safener selected from quinolinecarboxylic acid herbicides and agriculturally acceptable salts and esters thereof, cloquintocet mexyl, cyprosulfamide, mefenpyr, mefenpyr-diethyl, and combinations thereof.

The WG compositions according to the present disclosure can be employed for the selective control of grasses and annual and perennial monocotyledonous and dicotyledonous harmful plants the presence of useful plants such as maize, soya, peas, beans, sunflowers, oilseed rape, sugar cane, cassava, pumpkins, potatoes, vegetables and tobacco. Within the scope of this invention is also the control of such harmful plants found among transgenic useful plants or among useful plants selected by classical means which are resistant to bixlozone. Likewise, the WG compositions can be employed for controlling undesirable harmful plants in plantation crops.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES

### Example 1. Inventive Method of Preparation

An inventive method of preparation in accordance with the present disclosure is performed as follows. This method produces the water dispersible granule composition of Table 1.

First, all the ingredients of the composition are mixed and air-milled to produce a mixture having a median particle size of 5-8 micrometers. Next, water is added to the mixture over about one minute. The wetted mixture is stirred for an additional 3 minutes. Then the wetted mixture is fed into a paste extruder fitted with a 1 mm dome. Finally, the wet extrudate is dried in a fluid bed with a 60-65 °C inlet temperature for about 10-12 min. to provide the water dispersible granule of Table 1 with a moisture content of about ≤1.5%.

### Example 2. Inventive Composition

This example includes several commercially available materials. These materials are available from several different suppliers. For instance, bixlozone is available from FMC, one example of a benzenesulfonic acid, dodecyl-branched, sodium salt is available from Solvay, one example of a copolymer of maleic anhydride and diisobutylene, sodium salt and 5-10% sodium dodecylbenzenesulfonate is available from Solvay, one example of a sulfonated aromatic condensate, sodium salt is available from Nouryon, one example of a sodium tallowate is available from BASF, one example of an amorphous silica is available from PPG, and one example of a kaolin clay is available from Imerys. The example trade names shown in Table 1 are for reference only and are not intended to be limiting.

An inventive composition in accordance with the present disclosure is shown in Table 1. This composition did not settle during storage and therefore did not require mixing or shaking to resuspend any settled material before use. This composition also did not leave residue when poured out of a container.

Table 1. Inventive water dispersible granule composition.

| | | | Example Trade | |
|---|---|---|---|---|
| Wt % | Chemical Name | CAS | Name(s) | Functionality |
| 75 | Bixlozone | 81777-95-5 | N/A | Active ingredient |
| 1 | Benzenesulfonic acid, | 68608-89-9 or | Rhodocal | Wetting agent |
| | dodecyl-branched, sodium | 69227-09-4 | DS-10 | |
| | salt | | | |
| 7 | Copolymer of maleic | 37199-81-8 | Geropon TA 72 | Dispersant |
| | anhydride and | | | |
| | diisobutylene, sodium salt | | | |
| | and 5-10% sodium | | | |
| | dodecylbenzenesulfonate | | | |
| 5 | Sulfonated aromatic | 68425-94-5 | Morwet D425 | Dispersant |
| | condensate, sodium salt | | | |
| 1 | Sodium tallowate | 8052-48-0 | Agnique Soap L | Antifoam |
| 2 | Amorphous silica | 112926-00-8 | HiSil 233 | Flow aid |
| 9 | Kaolin clay | 1332-58-7 | Argirec B22 | Diluent/Carrier |

1. A water dispersible granule composition comprising:
(i) from greater than 50 wt % to about 90 wt % of bixlozone;
(ii) from about 0.01 wt % to about 5 wt % of a wetting agent;
(iii) from about 1 wt % to about 20 wt % of a dispersant; and
(iv) from about 1 wt % to about 20 wt % of a carrier.

2. The water dispersible granule composition of claim 1, wherein the wetting agent is selected from alkaline earth or ammonium salts of sulfonates, alkylarylsulfonates, sulfonates of dodecyl- and tridecylbenzenes, sodium dodecylbenzenesulfonate, and combinations thereof.

3. The water dispersible granule composition of claim 2, wherein the dispersant is selected from sodium polycarboxylate, copolymers of maleic anhydride and diisobutylene sodium salt and sodium dodecylbenzenesulfonate, sulfonated aromatic condensates, alkyl naphthalene sulfonates, lignosulfonate dispersants, and combinations thereof.

4. The water-dispersible granule composition of claim 3, wherein the dispersant includes a combination of at least two dispersants.

5. The water dispersible granule composition of claim 4, wherein the carrier is selected from mineral earths, clay, kaolin clay, and combinations thereof.

6. The water dispersible granule composition of claim 5, further comprising a defoamer.

7. The water dispersible granule composition of claim 6, further comprising from about 0.01 wt % to about 5 wt % of a defoamer.

8. The water dispersible granule composition of claim 7, wherein the defoamer is selected from silicones, long chain alcohols, fatty acids, salts of fatty acids, sodium tallowate, and combinations thereof.

9. The water dispersible granule composition of claim 8, further comprising a flow aid.

10. The water dispersible granule composition of claim 8, further comprising from about 0.01 wt % to about 5 wt % of a flow aid.

11. The water dispersible granule composition of claim 8, further comprising a flow aid selected from silicates, silica gel, amorphous silica, silica, and combinations thereof.

12. The water dispersible granule composition of claim 9, comprising:
(i) from about 65 wt % to about 80 wt % of bixlozone;
(ii) from about 0.1 wt % to about 2 wt % of a wetting agent;
(iii) from about 10 wt % to about 15 wt % of a dispersant;
(iv) from about 5 wt % to about 15 wt % of a carrier;
(v) from about 0.1 wt % to about 2 wt % of a defoamer; and
(vi) from about 0.1 wt % to about 5 wt % of a flow aid.

13. The water dispersible granule composition of claim 9, consisting of:
(i) from about 72 wt % to about 77 wt % of bixlozone;
(ii) from about 0.1 wt % to about 2 wt % of a wetting agent;
(iii) from about 10 wt % to about 15 wt % of a dispersant;
(iv) from about 5 wt % to about 15 wt % of a carrier;
(v) from about 0.1 wt % to about 2 wt % of a defoamer; and
(vi) from about 0.1 wt % to about 5 wt % of a flow aid.

14. The water dispersible granule composition of claim 9, consisting of:
(i) about 75 wt % of bixlozone;
(ii) about 1 wt % of a wetting agent;
(iii) about 12 wt % of a dispersant;
(iv) about 9 wt % of a carrier;
(v) about 1 wt % of a defoamer; and
(vi) about 2 wt % of a flow aid.

15. A method of preparing a water dispersible granule composition, the method comprising:
I) forming a mixture comprising:
(i) bixlozone;
(ii) a wetting agent;
(iii) a dispersant; and
(iv) a carrier; and
II) granulating the mixture.

16. The method of claim 15, wherein the mixture further comprises a defoamer.

17. (canceled)

18. The method of claim 15, wherein the mixture further comprises a flow aid.

19. (canceled)

20. The method of claim 18, wherein the method step of granulating the mixture occurs with a technique selected from paste extrusion, pan granulation, fluid bed granulation, and combinations thereof.

21. A method for controlling undesirable vegetation, the method comprising:
I) forming a mixture by dissolving in water a water dispersible granule composition comprising:
(i) from greater than 50 wt % to about 90 wt % of bixlozone;
(ii) from about 0.01 wt % to about 5 wt % of a wetting agent;
(iii) from about 1 wt % to about 20 wt % of a dispersant;
(iv) from about 1 wt % to about 20 wt % of a carrier; and
II) applying the mixture to the undesirable vegetation or to a locus thereof or applying to a soil or water to prevent an emergence or growth of the undesirable vegetation.

22. The method of claim 21, wherein the mixture further comprises a defoamer.

23. (canceled)

24. (canceled)

25. (canceled)

26. (canceled)

27. (canceled)

28. (canceled)

29. (canceled)
